(19) United States
(12) Patent Application Publication
(10) Pub. No.: US 2025/0272610 A1
(43) Pub. Date: Aug. 28, 2025

(54) DATA EXCHANGE SYSTEM AND DATA EXCHANGE METHOD FOR RETRAINING DECENTRALIZED ARTIFICIAL INTELLIGENCE SYSTEM

(71) Applicant: SEOUL UNIVERSITY OF FOREIGN STUDIES INDUSTRY ACADEMY COOPERATION FOUNDATION, Seoul (KR)

(72) Inventor: Keundug PARK, Seoul (KR)

(21) Appl. No.: 18/614,225

(22) Filed: Mar. 22, 2024

(30) Foreign Application Priority Data
Feb. 27, 2024 (KR) 10-2024-0028147

(51) Int. Cl. G06N 20/00

(52) U.S. Cl. CPC G06N 20/00

(57) ABSTRACT

A data exchange system for retraining decentralized artificial intelligence system includes blockchain system that receives first training result data generated through training by first artificial intelligence system and identifier of the first artificial intelligence system from the first artificial intelligence system and stores the first training result data and the identifier of the first artificial intelligence system in off-chain, receives second training result data generated through training by a second artificial intelligence system and an identifier of the second artificial intelligence system from the second artificial intelligence system and stores the second training result data and the identifier of the second artificial intelligence system in off-chain, transmits the second training result data and the identifier of the second artificial intelligence system to the first artificial intelligence system, and transmits the first training result data and the identifier of the first artificial intelligence system to the second artificial intelligence system.

### CROSS-REFERENCE TO RELATED APPLICATIONS

This application claims the benefit of Korean Patent Application No. 10-2024-0028147, filed on Feb. 27, 2024, the contents of which are all hereby incorporated by reference herein in their entirety.

### BACKGROUND

### Field of Invention

The present invention relates to a blockchain-based data exchange system, and more specifically, to a blockchain-based data exchange system for a plurality of artificial intelligence systems.

### Related Art

A blockchain platform makes forgery and falsification of data actually impossible because members (nodes) participating in a system distribute and store data in blocks of each members (nodes), allows each member (node) to hold distributed information, and doesn't need a separate administrator of a central server.

Artificial Intelligence (AI) technology is being used in a wide range of areas, including autonomous vehicles, robots, factory automation, and IoT (internet of things) devices, and on-device AI has recently been attracting attention.

As described above, the artificial intelligence technology is applied in various fields, applications using a machine learning/deep learning model are being developed, and this artificial intelligence models must be trained using training data in advance. Since training of an artificial intelligence model using a large amount of training data takes a lot of time and requires high-performance computing resources, protection of personal information sensitive to privacy becomes an issue when training of an artificial intelligence model is performed in a cloud and the training data is stored in the cloud.

In a distributed deep learning scheme for overcoming this, training data is divided, individual training is performed by a plurality of devices, and weights derived from training results are shared between each device and other devices. When a representative scheme such as D-PSGD or TreeEASGD for weight sharing is used, this is a P2P type and has a limitation that it is difficult to share weight data when a failure occurs in a specific node.

A distributed deep learning system that shares weights on the basis of a blockchain in the related art, a plurality of artificial intelligence systems has a structure in which uniformly divided training data is distributed from a centralized training database server, and since raw data for training containing personal information sensitive to privacy is stored in the centralized training database server, there is a problem that it is still difficult to solve privacy issues in existing artificial intelligence systems.

Meanwhile, when data on the Internet is collected and used for training of artificial intelligence, there is a risk of litigation due to data ownership or copyright issues, and recently, the data on the Internet is purchased for training of artificial intelligence. Recently, in the case of AI smartphones being developed with on-device artificial intelligence, an AI smartphone company itself collects paid Internet data and causes training of artificial intelligence to be performed only on the AI smartphone itself. Improvement of the performance of an artificial intelligence model of the AI smartphone itself is limited.

### Patent Document

(Patent Document 1) U.S. Patent Publication No. 2019-0228338 (Jul. 25, 2019, “Coordinated learning using distributed average consensus”)

### SUMMARY

The present invention is to provide a data exchange system and data exchange method for retraining a decentralized artificial intelligence system capable of improving the performance of artificial intelligence models of respective artificial intelligence systems, by the respective artificial intelligence systems training data including personal information sensitive to privacy and sharing training result data through a blockchain system.

However, the problem to be solved by the present invention is not limited thereto, and may be expanded in various ways without departing from the spirit and scope of the present invention.

A data exchange system for retraining a decentralized artificial intelligence system according to an aspect of the present invention includes a blockchain system configured to: receive first training result data generated through training by a first artificial intelligence system and an identifier of the first artificial intelligence system from the first artificial intelligence system and store the first training result data and the identifier of the first artificial intelligence system in an off-chain, receive second training result data generated through training by a second artificial intelligence system and an identifier of the second artificial intelligence system from the second artificial intelligence system and stores the second training result data and the identifier of the second artificial intelligence system in an off-chain, transmit the second training result data and the identifier of the second artificial intelligence system to the first artificial intelligence system, and transmit the first training result data and the identifier of the first artificial intelligence system to the second artificial intelligence system.

The blockchain system may receive the identifier and authentication information of the first artificial intelligence system from the first artificial intelligence system to identify and authenticate the first artificial intelligence system, and receive the identifier and authentication information of the second artificial intelligence system from the second artificial intelligence system to identify and authenticate the second artificial intelligence system.

The blockchain system may receive first training result data electronically signed with a private key of the first artificial intelligence system from the first artificial intelligence system, and store the identifier of the first artificial intelligence system and the first training result data in an off-chain when electronic signature verification is successful, and may receive second training result data electronically signed with a private key of the second artificial intelligence system from the second artificial intelligence system, and store the identifier of the second artificial intelligence system and the second training result data in an off-chain when electronic signature verification is successful.

The identifier of the first artificial intelligence system and a hash value of the first training result data may be stored in an on-chain, and the identifier of the second artificial intelligence system and a hash value of the second training result data may be stored in an on-chain.

The training result data may be a result of training raw data in artificial intelligence, the result being knowledge data containing adjusted parameters of an artificial intelligence model.

The first artificial intelligence system and the second artificial intelligence system perform artificial intelligence data training but do not perform a blockchain node function.

The first artificial intelligence system and the second artificial intelligence system may independently collect artificial intelligence training data and store the collected artificial intelligence training data in the first artificial intelligence system and the second artificial intelligence system, respectively.

The first artificial intelligence system may reuse or retrain the received second training result data and output a product containing the identifier of the first artificial intelligence system, and the second artificial intelligence system may reuse or retrain the received first training result data and output a product containing the identifier of the second artificial intelligence system.

Further, a data exchange method for retraining a decentralized artificial intelligence system according to another aspect of the present invention includes receiving, by a blockchain system, first training result data generated through training by a first artificial intelligence system and an identifier of the first artificial intelligence system from the first artificial intelligence system and storing the first training result data and the identifier of the first artificial intelligence system in an off-chain; receiving, by the blockchain system, second training result data generated through training by the second artificial intelligence system and an identifier of the second artificial intelligence system from the second artificial intelligence system and storing the second training result data and the identifier of the second artificial intelligence system in an off-chain; transmitting, by the blockchain system, the second training result data and the identifier of the second artificial intelligence system to the first artificial intelligence system; and transmitting, by the blockchain system, the first training result data and the identifier of the first artificial intelligence system to the second artificial intelligence system.

The data exchange method may further include receiving, by the blockchain system, the identifier and authentication information of the first artificial intelligence system from the first artificial intelligence system to identify and authenticate the first artificial intelligence system; and receiving, by the blockchain system, the identifier and authentication information of the second artificial intelligence system from the second artificial intelligence system to identify and authenticate the second artificial intelligence system.

The data exchange method may further include receiving, by the blockchain system, first training result data electronically signed with a private key of the first artificial intelligence system from the first artificial intelligence system, and storing the identifier of the first artificial intelligence system and the first training result data in an off-chain when electronic signature verification is successful; and receiving, by the blockchain system, second training result data electronically signed with a private key of the second artificial intelligence system from the second artificial intelligence system, and storing the identifier of the second artificial intelligence system and the second training result data in an off-chain when electronic signature verification is successful.

The data exchange method may further include storing the identifier of the first artificial intelligence system and a hash value of the first training result data in an on-chain; and storing the identifier of the second artificial intelligence system and a hash value of the second training result data in an on-chain.

The training result data may be a result of training raw data in artificial intelligence, the result being knowledge data containing adjusted parameters of an artificial intelligence model.

The first artificial intelligence system and the second artificial intelligence system perform artificial intelligence data training but do not perform a blockchain node function.

The data exchange method may further include independently collecting, by the first artificial intelligence system and the second artificial intelligence system, artificial intelligence training data and storing the collected artificial intelligence training data in the first artificial intelligence system and the second artificial intelligence system, respectively.

The data exchange method may further include reusing or retraining, by the first artificial intelligence system, the received second training result data and outputting a product containing the identifier of the first artificial intelligence system; and reusing or retraining, by the second artificial intelligence system, the received first training result data and outputting a product containing the identifier of the second artificial intelligence system.

The disclosed technology can have the following effects. However, since it is not meant that a specific embodiment must include all of the following effects or only the following effects, the scope of rights of the disclosed technology should not be understood as being limited thereby.

With the data exchange system for retraining a decentralized artificial intelligence system according to the embodiments of the present invention described above, it is possible to continuously improve the performance of artificial intelligence models of artificial intelligence systems participating in the data exchange system for retraining a decentralized artificial intelligence system, and improve a knowledge level of the artificial intelligence systems, by receiving and sharing training result data generated through training by another artificial intelligence system from a decentralized blockchain system rather than a separate centralized server.

Further, with the data exchange system for retraining a decentralized artificial intelligence system according to the embodiments of the present invention, it is possible to implement an artificial intelligence ecosystem capable of using less data traffic compared to sharing through a centralized server and continuously perform training without a centralized system, by receiving and sharing training result data generated through training by another artificial intelligence system from a decentralized blockchain system rather than a separate centralized server.

Further, with the data exchange system for retraining a decentralized artificial intelligence system according to the embodiments of the present invention, it is possible to limit the generation of pseudo information and false information due to data bias by a large number of users of smartphones such as AI smartphones around the world sharing training result data generated through training on the AI smartphones through a decentralized blockchain system.

Further, with the data exchange system for retraining a decentralized artificial intelligence system according to the embodiments of the present invention, it is possible to reduce a cost of securing training data when data is collected from the Internet, and to shorten an artificial intelligence training time and maximize an artificial intelligence training effect with limited data stored in the artificial intelligence system, by sharing the training result data generated through training by the other artificial intelligence systems instead of sharing data collected from the Internet by other artificial intelligence systems from the decentralized blockchain system.

Further, with the data exchange system for retraining a decentralized artificial intelligence system according to the embodiments of the present invention, it is possible to implement a crowd sourcing-based artificial intelligence ecosystem through a financial incentive through sales of training result data of an artificial intelligence training system when training result data generated through training by other artificial intelligence systems is shared from a decentralized blockchain system.

### BRIEF DESCRIPTION OF THE DRAWINGS

FIG. 1 is a conceptual diagram showing a data exchange system for retraining s decentralized artificial intelligence system according to an embodiment of the present invention.

FIG. 2 is a flowchart showing a data exchange method for retraining the decentralized artificial intelligence system according to the embodiment of the present invention.

### DESCRIPTION OF EXEMPLARY EMBODIMENTS

Since various changes may be made to the present invention and there are various embodiments, specific embodiments will be illustrated in the drawings and described in detail.

However, this is not intended to limit the present invention to the specific embodiments, and should be understood to include all changes, equivalents, and substitutes included in the spirit and technical scope of the present invention.

Terminologies such as first and second may be used to describe various components, but the components should not be limited by the terms. The terms are used only for the purpose of distinguishing one component from other components. For example, a first component may be referred to as a second component without departing from the scope of the present invention, and similarly, the second component may also be referred to as a first component.

When a component is said to be “connected” or “coupled” to another component, it should be understood that the component may be directly connected or coupled to the other component, but that other components may exist therebetween. On the other hand, when a component is said to be “directly connected” or “directly coupled” to another component, it should be understood that there are no other components therebetween.

The terminology used herein is only used for the purpose of describing specific embodiments and is not intended to limit the present disclosure. Singular forms “a,” “an” and “the” include plural forms unless the context clearly indicates otherwise. It will be further understood that terms “include”, “have”, etc. used herein designate the presence of features, integers, steps, operations, components, parts, or combinations thereof, but do not preclude a likelihood of the presence or addition of one or more other features, integers, steps, operations, components, parts, and/or combinations thereof.

Unless otherwise defined, all terms used herein, including technical and scientific terms, have the same meaning as commonly understood by those skilled in the art to which the present disclosure belongs. Terms such as those defined in commonly used dictionaries should be construed as having meanings consistent with their meaning in the context of the relevant art and will not be construed as having idealized or overly formal meanings unless expressly defined herein.

Hereinafter, preferred embodiments of the present invention will be described clearly and in detail with reference to the accompanying drawings so that a person skilled in the art can easily implement the present invention.

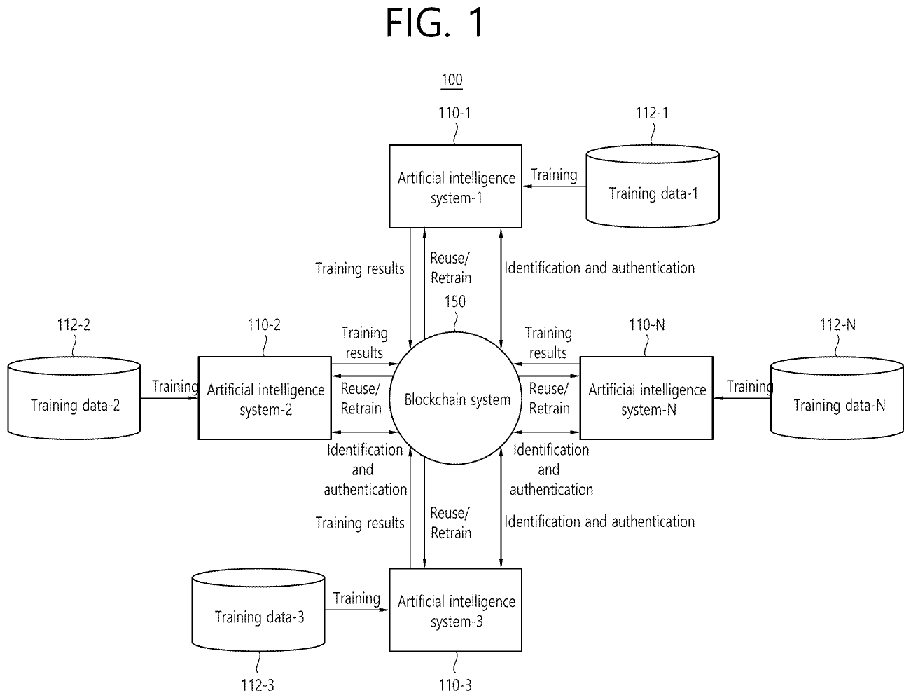

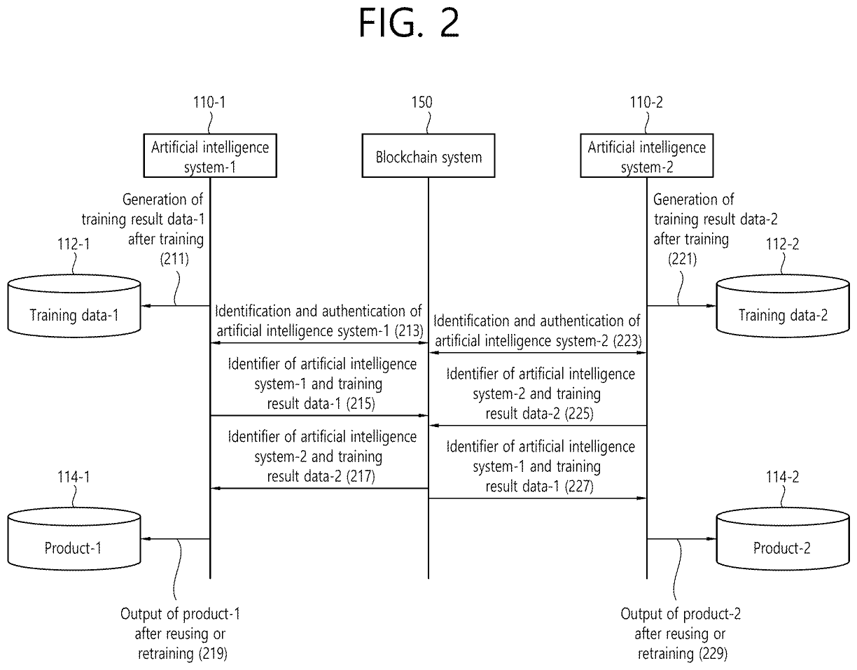

FIG. 1 is a conceptual diagram showing a data exchange system for retraining a decentralized artificial intelligence system according to the embodiment of the present invention. FIG. 2 is a flowchart showing a data exchange method for retraining the decentralized artificial intelligence system according to the embodiment of the present invention.

Referring to FIG. 1, a data exchange system 100 includes a plurality of artificial intelligence systems 110-1, 110-2, 110-3, and 110-N, training data 112-1, 112-2, 112-3, and 112-N connected to the respective artificial intelligence systems, and a blockchain system 150.

The artificial intelligence system may include, for example, an on-device AI system (a device, an apparatus, or a system) such as an AI smartphone, an AI laptop, an AI PC, an AI robot, or an autonomous vehicle.

Hereinafter, a data exchange method for retraining the decentralized artificial intelligence system according to the embodiment of the present invention will be described with reference to FIGS. 1 and 2.

First, the artificial intelligence system-1 110-1 collects various types of pieces of data, performs training of artificial intelligence on the training data-1 112-1 held therein, and then generates training result data-1 (step 211).

With the training of artificial intelligence, for example, in the case of deep learning, training data may be trained, and parameters of a deep learning model may be adjusted. The training result data is knowledge data for solving a problem and may include parameters of an existing artificial intelligence model according to a training result. Hereinafter, deep learning model parameters may include a weight and a bias.

Further, the artificial intelligence system-2 110-2 collects various types of pieces of data, performs training of artificial intelligence on the training data-2 112-2 held therein, and then generates training result data-2 (step 221).

For example, when the artificial intelligence system is an AI smartphone, the artificial intelligence system-1 110-1 may be an AI smartphone of user A, and the artificial intelligence system-2 110-2 may be an AI smartphone of user B.

When the artificial intelligence system-1 110-1 is the AI smartphone of user A, the artificial intelligence system-1 110-1 may perform the training of artificial intelligence on various types of pieces of data such as voice call content, video call content, text conversation content, SNS search result data, Internet search result data, and email content of user A, and generate the training result data-1.

The data collected by the artificial intelligence system-1 110-1 is trained as data used by user A at the time of working within the AI smartphone of user A (which is not data collected from an external Internet), such as a call, text conversation, SNS use, Internet search, and e-mail.

The training result data may be said to be knowledge data including adjusted parameters of an existing artificial intelligence model with raw data learned by the artificial intelligence. The parameters may be part of the knowledge data and may only be applied to the same type of artificial intelligence system, but the knowledge data may be applied to both the same type of artificial intelligence system and a different type of artificial intelligence system.

For example, the artificial intelligence system-1 110-1 may adjust the weight and the bias to generate an artificial intelligence model for user A while training the voice call data of user A, and generate adjusted parameters of the generated artificial intelligence model as the training result data-1 of user A.

When the artificial Intelligence system-2 110-2 is the AI smartphone of user B, the artificial Intelligence system-2 110-2 may collect various types of pieces of data such as voice call content, video call content, text conversation content, SNS content, Internet search results, and email content of user B, perform training of artificial intelligence, and generate the training result data-2. For example, the artificial intelligence system-2 110-2 may generate an artificial intelligence model for user B by adjusting the parameters while training voice call data of user B, and generate the adjusted parameters of the generated artificial intelligence model as the training result data-1 of user B. Here, the data collected and learned by the artificial intelligence system-2 110-2 is not data collected from the external Internet, but is data used by user B within the AI smartphone of user B.

The blockchain system 150 receives an identifier and authentication information of the artificial intelligence system-1 110-1 from the artificial intelligence system-1 110-1 to identify and authenticate the artificial intelligence system-1 110-1 (step 213). For example, when the artificial intelligence system-1 110-1 is the AI smartphone of user A, the blockchain system 150 may perform authentication using an identifier and authentication information of the AI smartphone of user A.

The artificial intelligence system-1 110-1 transmits training result data-1 electronically signed with its own private key to the blockchain system 150, and stores the identifier of the artificial intelligence system-1 110-1 and the training result data-1 in an off-chain when electronic signature verification is successful (step 215), and stores the identifier of the artificial intelligence system-1 110-1 and a hash value of the training result data-1 in an on-chain. That is, the identifier of the artificial intelligence system-1 110-1 and the training result data-1 are stored in the outside (Off) (a database connected to the blockchain) other than the blockchain, and the identifier of the artificial intelligence system-1 110-1) and the hash value of the training result data-1 are stored on the blockchain. Since the training result data with the identifier of the artificial intelligence system-1 110-1 inserted thereinto is stored, when a problem occurs later due to false information or deep fake, an artificial intelligence system generating the training result data is traced back so that the artificial intelligence system can be prevented from sharing training result data any longer.

Further, the blockchain system 150 receives an identifier and authentication information of the artificial intelligence system-2 110-2 from the artificial intelligence system-2 110-2 to identify and authenticate the artificial intelligence system-2 110-2 (step 223). For example, when the artificial intelligence system-2 110-2 is AI smartphone of user B, the blockchain system 150 can perform authentication using the identifier and authentication information of the AI smartphone of user B.

The artificial Intelligence system-2 110-2 transmits the training result data-2 electronically signed with its own private key to the blockchain system 150, and stores the identifier of the artificial Intelligence system-2 110-2 and training result data-2 in an off-chain when electronic signature verification is successful (step 225), and stores the identifier of the artificial intelligence system-2 110-2 and a hash value of the training result data-2 an on-chain (on-chain). That is, the identifier of the artificial intelligence system-2 110-2 and the training result data-2 are stored in the outside (Off) (a database connected to the blockchain) other than the blockchain, and the identifier of the artificial intelligence system-2 110-2 and the hash value of the training result data-2 are stored on the blockchain.

The artificial intelligence system-1 110-1 receives the identifier of the artificial intelligence system-2 110-2 and the training result data-2 from the blockchain system (step 217).

Although a case where the artificial intelligence system-1 110-1 receives the training result data from another artificial intelligence system from the blockchain system has been described with reference to FIG. 2, the artificial intelligence system-1 110-1 may receive the training result data from N−1 (N is a natural number equal to or greater than 2) artificial intelligence systems 110-2, 110-3, and 110-N other than the artificial intelligence system-1 110-1 from the blockchain system, and share result data learned in the N−1 (N is a natural number equal to or greater than 2) artificial intelligence systems, as shown in FIG. 1.

Here, the training result data from the N−1 artificial intelligence systems 110-2, 110-3, and 110-N other than the artificial intelligence system-1 110-1 may be stored by type in different storage areas, which are off-chains, depending on a type of data learned by artificial intelligence, such as voice call content, video call content, text conversation content, SNS content, and Internet search results, and email content.

The artificial intelligence system-1 110-1 may be implemented to receive only the training result data selected for each data type and corresponding to the predetermined data type instead of fetching all the pieces of training result data from the other artificial intelligence systems. For example, a setting is made so that only training result data for interpretation or translation, pictures, videos, or conversations of the AI smartphones of the other users are received.

Here, the reception of the training result data from the N−1 artificial intelligence systems may be reception of respective pieces of the training result data from the N−1 artificial intelligence systems simultaneously or sequentially.

The artificial intelligence system-1 110-1 can periodically receive the training result data from the other artificial intelligence systems from the blockchain system. A reception time can be set in advance so that the reception is performed using late night or early morning hours when a workload of the artificial intelligence system is low or a data transmission amount of a network is small.

A reception period can be set to a preset value. The preset value may be set, for example, in units of hour, day, week, or month, but is not limited thereto.

The artificial intelligence system-1 110-1 reuses or retrains the received training result data-2 to generate and output product-1 containing the identifier of the artificial intelligence system-1 110-1 (step 219). For example,

The AI smartphone of user A may receive training result data including parameters of the artificial intelligence model improved (updated) by the AI smartphone of user B, who performs a lot of specific tasks (for example, translation or SNS search), training specific task data, and performs retraining using the training result data including the parameters of the artificial intelligence model improved (updated) by the AI smartphone of user B to generate a further improved product (for example, translation).

The training result data may be received from the same type of artificial intelligence system, but is not limited thereto and may be received from a different types of artificial intelligence system. For example, when the artificial intelligence system-1 110-1 is an AI smartphone available from Samsung Electronics and the artificial intelligence system-2 110-2 is an AI smartphone available from Apple, the AI smartphone available from Samsung Electronics may receive the training result data from the AI smartphone available from Apple, and reuse or relearn the training result data.

Here, the reusing means using the training result data received from the other artificial intelligence system as it is, in addition to the training data generated by the artificial intelligence system, and the retraining means gradually retraining all data or only a changed part using the training result data received from other artificial intelligence systems in addition to the training data generated by the artificial intelligence system.

The product may refer to a result that can be generated by the artificial intelligence, such as text (translations, reports, word documents, PowerPoint documents, audio summary texts, or the like), images (pictures or videos), and sounds (songs or musical pieces).

The artificial intelligence system-2 110-2 receives the identifier of the artificial intelligence system-1 110-1 and the training result data-1 from the blockchain system (step 227).

The artificial intelligence system-2 110-2 reuses or retrains the received training result data-1 to generate and output product-2 containing the identifier of the artificial intelligence system-2 110-2 (step 229).

With the data exchange system for retraining of the decentralized artificial intelligence system described above, each artificial intelligence system learns data including personal information sensitive to privacy, each artificial intelligence system stores the training result data to the off-chain of the blockchain, and each artificial intelligence system can continuously improve the performance of artificial intelligence models of artificial intelligence systems participating in the data exchange system for retraining a decentralized artificial intelligence system, by receiving and sharing training result data generated through training by another artificial intelligence system from the decentralized blockchain system. For example, it is possible to improve the quality of interpretation by a plurality of AI smartphone users traveling in a specific area interpreting a phone call for hotel reservation, restaurant reservation, performance reservation, or the like in real time, training interpretation data, and sharing training result data including parameters of the artificial intelligence model for interpretation.

Each of the operations of the data exchange system and data exchange method for retraining a decentralized artificial intelligence system according to the embodiments of the present invention described above can be implemented as computer-readable code in a computer-readable storage medium.

Each of operations of the data exchange system and data exchange method for retraining a decentralized artificial intelligence system according to the embodiments of the present invention described above can be implemented as software stored in a computer-readable storage medium.

Each of operations of the data exchange system and data exchange method for retraining a decentralized artificial intelligence system according to the embodiments of the present invention described above can be implemented as a program transmitted through a wired or wireless network.

A computer-readable storage medium includes all types of storage media that store data that can be deciphered by a computer system. For example, there may be a read only memory (ROM), a random access memory (RAM), a magnetic tape, a magnetic disk, a flash memory, an optical data storage device, or the like. Further, the computer-readable storage media may be distributed to computer systems connected through a computer communication network, and the operation may be stored and executed as code that can be read in a distributed manner.

Although the present invention has been described above with reference to the drawings and embodiments, it is not meant that the scope of protection of the present invention is limited by the drawings or embodiments, and those skilled in the art will understand that various modifications and changes can be made to the present invention without departing from the spirit and scope of the present invention as set forth in the following claims.

What is claimed is:

1. A data exchange system for retraining a decentralized artificial intelligence system, the data exchange system comprising a blockchain system configured to:
receive first training result data generated through training by a first artificial intelligence system and an identifier of the first artificial intelligence system from the first artificial intelligence system and store the first training result data and the identifier of the first artificial intelligence system in an off-chain,
receive second training result data generated through training by a second artificial intelligence system and an identifier of the second artificial intelligence system from the second artificial intelligence system and stores the second training result data and the identifier of the second artificial intelligence system in an off-chain,
transmit the second training result data and the identifier of the second artificial intelligence system to the first artificial intelligence system, and
transmit the first training result data and the identifier of the first artificial intelligence system to the second artificial intelligence system.

2. The data exchange system of claim 1, wherein the blockchain system receives the identifier and authentication information of the first artificial intelligence system from the first artificial intelligence system to identify and authenticate the first artificial intelligence system, and receives the identifier and authentication information of the second artificial intelligence system from the second artificial intelligence system to identify and authenticate the second artificial intelligence system.

3. The data exchange system of claim 2, wherein the blockchain system
receives first training result data electronically signed with a private key of the first artificial intelligence system from the first artificial intelligence system, and stores the identifier of the first artificial intelligence system and the first training result data in the off-chain when electronic signature verification is successful, and
receives second training result data electronically signed with a private key of the second artificial intelligence system from the second artificial intelligence system, and stores the identifier of the second artificial intelligence system and the second training result data in the off-chain when electronic signature verification is successful.

4. The data exchange system of claim 1, wherein the identifier of the first artificial intelligence system and a hash value of the first training result data are stored in an on-chain, and the identifier of the second artificial intelligence system and a hash value of the second training result data are stored in an on-chain.

5. The data exchange system of claim 1, wherein the training result data is a result of training raw data in artificial intelligence, the result being knowledge data containing adjusted parameters of an artificial intelligence model.

6. The data exchange system of claim 1, wherein the first artificial intelligence system and the second artificial intelligence system perform artificial intelligence data training but do not perform a blockchain node function.

7. The data exchange system of claim 1, wherein the first artificial intelligence system and the second artificial intelligence system independently collect artificial intelligence training data and store the collected artificial intelligence training data in the first artificial intelligence system and the second artificial intelligence system, respectively.

8. The data exchange system of claim 1, wherein
the first artificial intelligence system reuses or retrains the received second training result data and outputs a product containing the identifier of the first artificial intelligence system, and
the second artificial intelligence system reuses or retrains the received first training result data and outputs a product containing the identifier of the second artificial intelligence system.

9. A data exchange method for retraining a decentralized artificial intelligence system, the data exchange method comprising:
receiving, by a blockchain system, first training result data generated through training by a first artificial intelligence system and an identifier of the first artificial intelligence system from the first artificial intelligence system and storing the first training result data and the identifier of the first artificial intelligence system in an off-chain;
receiving, by the blockchain system, second training result data generated through training by the second artificial intelligence system and an identifier of the second artificial intelligence system from the second artificial intelligence system and storing the second training result data and the identifier of the second artificial intelligence system in an off-chain;
transmitting, by the blockchain system, the second training result data and the identifier of the second artificial intelligence system to the first artificial intelligence system; and
transmitting, by the blockchain system, the first training result data and the identifier of the first artificial intelligence system to the second artificial intelligence system.

10. The data exchange method of claim 9, further comprising:
receiving, by the blockchain system, the identifier and authentication information of the first artificial intelligence system from the first artificial intelligence system to identify and authenticate the first artificial intelligence system; and
receiving, by the blockchain system, the identifier and authentication information of the second artificial intelligence system from the second artificial intelligence system to identify and authenticate the second artificial intelligence system.

11. The data exchange method of claim 10, further comprising:
receiving, by the blockchain system, first training result data electronically signed with a private key of the first artificial intelligence system from the first artificial intelligence system, and storing the identifier of the first artificial intelligence system and the first training result data in the off-chain when electronic signature verification is successful; and
receiving, by the blockchain system, second training result data electronically signed with a private key of the second artificial intelligence system from the second artificial intelligence system, and storing the identifier of the second artificial intelligence system and the second training result data in the off-chain when electronic signature verification is successful.

12. The data exchange method of claim 9, further comprising:
storing the identifier of the first artificial intelligence system and a hash value of the first training result data in an on-chain; and
storing the identifier of the second artificial intelligence system and a hash value of the second training result data in an on-chain.

13. The data exchange method of claim 9, wherein the training result data is a result of training raw data in artificial intelligence, the result being knowledge data containing adjusted parameters of an artificial intelligence model.

14. The data exchange method of claim 9, wherein the first artificial intelligence system and the second artificial intelligence system perform artificial intelligence data training but do not perform a blockchain node function.

15. The data exchange method of claim 9, further comprising: independently collecting, by the first artificial intelligence system and the second artificial intelligence system, artificial intelligence training data and store the collected artificial intelligence training data in the first artificial intelligence system and the second artificial intelligence system, respectively.

16. The data exchange method of claim 9, further comprising:
reusing or retraining, by the first artificial intelligence system, the received second training result data and outputting a product containing the identifier of the first artificial intelligence system; and
reusing or retraining, by the second artificial intelligence system, the received first training result data and outputting a product containing the identifier of the second artificial intelligence system.
